(19) United States
(12) Patent Application Publication
(10) Pub. No.: US 2023/0278246 A1
(43) Pub. Date: Sep. 7, 2023

(54) COOLING/HEATING SHAVER

(71) Applicant: Guangzhou Weidi Technology Co., Ltd., Guangdong (CN)

(72) Inventors: Zhijian HUANG, Guangdong (CN); Sanhu WANG, Guangdong (CN); Zehan SHI, Guangdong (CN)

(73) Assignee: Guangzhou Weidi Technology Co., Ltd., Guangdong (CN)

(21) Appl. No.: 18/314,782

(22) Filed: May 9, 2023

Related U.S. Application Data
(63) Continuation of application No. PCT/CN2022/133830, filed on Nov. 23, 2022.

(30) Foreign Application Priority Data
Dec. 14, 2021 (CN) 202111532116.6

(51) Int. Cl. B26B 21/48; B26B 21/22; B26B 21/52; B26B 21/40

(52) U.S. Cl. CPC B26B 21/48; B26B 21/225; B26B 21/521; B26B 21/4062; B26B 21/4043; B26B 21/405

(57) ABSTRACT

A cooling/heating shaver includes a cutter head, a handle, a blade group, a tactile sheet, a heat transfer block and an energy module; the blade group is detachably fixed on an outer side of the cutter head, and the energy module is disposed inside the cutter head; the tactile sheet is disposed on a side of the energy module close to the blade group, and the heat transfer block is disposed on the other side of the energy module; and the cutter head is connected to the handle.

### CROSS-REFERENCE TO RELATED APPLICATION

This application is a continuation of international application of PCT application serial no. PCT/CN2022/133830 filed on Nov. 23, 2022, which claims the priority benefit of China application no. 202111532116.6 filed on Dec. 14, 2021. The entirety of each of the above mentioned patent applications is hereby incorporated by reference herein and made a part of this specification.

### FIELD

The present disclosure belongs to the technical field of shavers, in particular related to cooling/heating shavers.

### BACKGROUND

Shaving, commonly known as beard shaving, involves removing objects from the surface with a knife. Beards generally refer to the hair growing on the upper lip, chin, face, cheekbones or neck of a man. However, when people pick up shavers, psychological satisfaction may be accompanied with physical pain, because a bloody wound is scratched by a blade. Now, these troubles can be completely under control. In the past 150 years, people have invented safety razors, removable blades, electric shavers and shaving cream.

When electric shaver is working, a large amount of heat may be generated between blades due to the high-speed relative rotation and friction between blades in a cutting unit, causing temperature rise of the cutting unit. When skin is in contact with the cutting unit, such high temperature will cause discomfort of skin.

Before shaving, the skin needs hot compress to soften the beard and skin for easy shaving. During and after shaving, apply ice compress on the skin to harden the beard and relieve the pain brought by shaving at the same time. However, shavers on the market do not have the effects of both hot and cold compress at the same time, which cannot meet the shaving needs of users, and the use experience is mediocre. Meanwhile, manual shavers on the market are complicated to assemble, and the cutter head is assembled from a plurality of parts resulting in poor stability, inconvenient disassembly, and cumbersome processing procedures.

### SUMMARY

The objective of the present disclosure is to provide a cooling/heating shaver which has a simple structure, is easy to replace blades, and has the effects of cold and hot compress at the same time.

The present disclosure provides a cooling/heating shaver including a cutter head, a handle, a blade group, a tactile sheet, a heat transfer block and an energy module.

The blade group is detachably fixed on the outside of the cutter head, and the energy module is disposed inside the cutter head; the tactile sheet is disposed on one side of the energy module close to the blade group, and the heat transfer block is disposed on the other side of the energy module; the cutter head is connected to the handle.

In some embodiments, the cutter head includes a fixed cover and a cutter head body; the fixed cover covers the cutter head body, and the blade group is detachably fixed on one outer side of the fixed cover; the cutter head body is provided with a groove, so that an accommodating cavity is formed between the cutter head body and the fixed cover; the tactile sheet and the energy module are disposed inside the accommodating cavity.

In some embodiments, the cutter head further includes a heat inducing block, and the heat inducing block is disposed between the tactile sheet and the energy module.

In some embodiments, the cooling/heating shaver further includes a connecting seat rotatably mounted on the handle and torsion springs mounted on the connecting seat; one end of each torsion spring is connected to the handle, the other end of each torsion spring is connected to the connecting seat, and the cutter head is mounted on the connecting seat.

In some embodiments, the cooling/heating shaver further includes connecting frames mounted on the handle; the connecting frames are mounted on the handle; the connecting seat is rotatably mounted on the connecting frames; the connecting seat is provided with limiting grooves; the torsion springs are mounted in the limiting grooves. One end of each torsion spring is connected to the handle, and the other end of each torsion spring is connected to the connecting seat. The cutter head is provided with a sleeve groove, and the connecting seat is clamped in the sleeve groove.

In some embodiments, the cooling/heating shaver further includes a pushing seat, a sliding seat, a first spring, a clamping seat and second springs.

The handle is provided with a sliding groove, a pressing hole and protruding holes; both of the pressing hole and the protruding holes communicate with the sliding groove; the sliding seat is slidably disposed in the sliding groove; the pushing seat is connected to the sliding seat and extends out of the sliding groove through the pressing hole; one end of the first spring is connected to the sliding seat, and the other end of the first spring is connected to an inner wall of the sliding groove, and the protruding holes are located on a moving path of the sliding seat.

The cutter head is provided with connecting holes; the clamping seat is slidably disposed on the connecting seat and is located on the moving path of the sliding seat, the connecting holes are located on a moving path of the clamping seat. One end of each second spring is connected to the clamping seat, and the other end of each second spring is connected to the connecting seat.

In some embodiments, the cooling/heating shaver further includes a sideburn cutter group; the cutter head is provided with a first mounting surface, a second mounting surface and a third mounting surface, which are connected in sequence; the first mounting surface is set facing away from the third mounting surface; the blade group is mounted on the first mounting surface; the cutter head is provided with buckles, and the sideburn cutter group is provided with clamping grooves and is mounted on the second mounting surface through the cooperation of the clamping grooves and the buckles.

In some embodiments, the sideburn cutter group includes a cutter holder and scrapers mounted on the cutter holder; the cutter holder is provided with a positioning groove, which runs through the cutter holder, and the second mounting surface is provided with a first positioning block, a second positioning block, a first engaging block and a second engaging block; the first positioning block is spaced apart from the second positioning block. The first engaging block and the second engaging block are spaced apart between the first positioning block and the second positioning block. The cutter holder is clamped between the first positioning block and the second positioning block, and the first engaging block and the second engaging block are both engaged in the positioning groove.

The positioning groove is provided with a first inner wall, a second inner wall, a bottom wall, a third inner wall and a fourth inner wall, which are connected in sequence; the first inner wall and the fourth inner wall are parallel to each other and are both perpendicular to the bottom wall. The second inner wall and the third inner wall are both arc-shaped; both the first engaging block and the second engaging block are provided with a first side wall, a second side wall, a top wall, a third side wall and a fourth side wall, which are connected in sequence. Two ends of the first inner wall abut against the first side walls of the first engaging block and the second engaging block respectively; two ends of the second inner wall abut against the second side walls of the first engaging block and the second engaging block respectively; two ends of the third inner wall abut against the third side walls of the first engaging block and the second engaging block respectively; two ends of the fourth inner wall abut against the fourth side walls of the first engaging block and the second engaging block respectively; two ends of the bottom wall abut against the top walls of the first engaging block and the second engaging block respectively.

A first arc surface and a second arc surface are provided on an outer side of the cutter holder; the first arc surface is parallel to the second inner wall; the second arc surface is parallel to the third inner wall; the first arc surface is provided with a first mounting groove; the second arc surface is provided with a second mounting groove; the first mounting groove and the second mounting groove are spaced apart along the arrangement direction of the first mounting surface and the third mounting surface. Residue discharging holes are disposed in the bottom wall of the first mounting groove. Both the residue discharging holes and the second mounting groove communicate with the positioning groove, and the second mounting groove is provided with a plurality of shaving knives scrapers, which are arranged in sequence along the extending direction of the positioning groove.

In some embodiments, the cooling/heating shaver further includes a control circuit board, a battery, a control button disposed on the handle, and a light emitting sheet electrically connected to the control circuit board; the handle is further provided with a mounting cavity; the control circuit board and the battery are both mounted inside the mounting cavity, and the control button, the battery and the energy module are all electrically connected to the control circuit board.

The control button has a first control position and a second control position; when the control button is at the first control position, a current of the control circuit board flows in the first direction, and the light emitting sheet emits a first light beam; and when the control button is at the second control position, the current of the control circuit board flows opposite to the first direction, and the light emitting sheet emits a second light beam.

In some embodiments, the cooling/heating shaver further includes a charging stand, which is provided with a charging slot, and a charging connector is disposed in the charging slot. One end of the handle is inserted into the charging slot and is provided with a first charging port adapted to the charging connector; the first charging port is electrically connected to the battery, and the charging stand is provided with a second charging port electrically connected to the charging connector.

The cooling/heating shaver of the present disclosure includes a cutter head and a handle. The energy module is disposed inside the cutter head; and after the energy module is powered on, one side of the energy module absorbs heat, and the other side of the energy module releases heat. The tactile sheet is disposed on the side of the energy module close to the blade group. The tactile sheet can transfer the heat of the energy module and is in direct contact with the skin so as to achieve the effects of ice compress or hot compress.

When the electrodes of the energy module of the cooling/heating shaver provided by the present disclosure are exchanged, the current of the energy module is reversed, and thus, the mode of ice compress or hot compress can be switched. The heat transfer block is disposed on a side of the energy module which is away from the tactile sheet; the cutter head body is connected to the handle; the heat transfer block can transfer the heat from the other side of the energy module to the handle; when the tactile sheet is set to ice compress mode, the heat transfer block transfers the heat from the other side to the handle, which is conducive to the heat dissipation of the energy module and also warms the hands to achieve the effect of making full use of energy. The blade group is detachably fixed on the outer side of the cutter head, which facilitates blade replacement.

### BRIEF DESCRIPTION OF THE DRAWINGS

FIG. 1 is a schematic structural view of a cooling/heating shaver of embodiment 1;

FIG. 2 is an exploded view of FIG. 1;

FIG. 3 is a schematic structural view of the cutter head, the handle, the blade group and the charging stand of embodiment 1;

FIG. 4 is a schematic structural view of the cutter head, the handle and the blade group of embodiment 1;

FIG. 5 is a schematic structural view of another perspective of FIG. 4;

FIG. 6 is an enlarged view of part A in FIG. 5;

FIG. 7 is a top view of the assembly view of the cutter head, the blade group and the handle of embodiment 1;

FIG. 8 is a sectional view at B-B in FIG. 7;

FIG. 9 is an enlarged view of part C in FIG. 8;

FIG. 10 is a schematic view of connection of the cutter head, the connecting seat, the pushing seat, the sliding seat, the first spring and connecting frames of embodiment 1;

FIG. 11 is a schematic view of connection of the cutter head, the connecting seat, the blade group and the sideburn cutter group in embodiment 1;

FIG. 12 is a schematic structural view of the cutter head body of the cutter head of embodiment 1;

FIG. 13 is a schematic view of connection of the sideburn cutter group, the blade group and the fixed cover of the cutter head of embodiment 1;

FIG. 14 is a schematic structural view of the connecting frames, the handle, the pushing seat, the sliding seat and the first spring of embodiment 1;

FIG. 15 is a schematic structural view of the connecting frames, the connecting seat, the heat transfer block, the tactile sheet, the energy module, the cutter head and the clamping seat of embodiment 1;

FIG. 16 is a schematic structural view of the connecting seat, the heat transfer block, the tactile sheet, the energy module and the torsion springs of embodiment 1;

FIG. 17 is a schematic structural view of the sideburn cutter group and the cutter head body of the cutter head in embodiment 1;

FIG. 18 is a schematic structural view of the sideburn cutter group in embodiment 1;

FIG. 19 is a schematic view of connection of the pushing seat, the sliding seat and the first spring in embodiment 1;

FIG. 20 is a schematic view of connection of the clamping seat and the second springs in embodiment 1;

FIG. 21 is a schematic view of a three-dimensional structure of embodiment 2;

FIG. 22 is an exploded view of embodiment 2;

FIG. 23 is a schematic view of a three-dimensional structure of embodiment 2;

FIG. 24 is a schematic structural view of the cutter head body of embodiment 2;

FIG. 25 is a schematic structural view of the handle of embodiment 2;

FIG. 26 is a schematic structural view of the cutter head of embodiment 3.

### DETAILED DESCRIPTION OF THE EMBODIMENTS

The specific implementations of the present disclosure will be further described in detail below in conjunction with the accompanying drawings and embodiments. The following embodiments are intended to describe the present disclosure, rather than to limit the scope of the present disclosure.

In the description of the present disclosure, it should be understood that directional or positional relationships indicated by terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise” and “counterclockwise” are directional or positional relationships based on the accompanying drawings, which are merely intended to facilitate describing the present disclosure and simplifying the description, rather than to indicate or imply that the appointed device or element has to be located in a specific direction or structured and operated in the specific direction so as not to be understood as restrictions on the present disclosure.

In the description of the present disclosure, it should be noted that unless explicitly specified and defined otherwise, terms such as “mounted”, “connected”, “connection”, “connect”, “communicate”, “abutted” and “clamped” are to be understood in a broad sense. For example, connection may be fixed connection or detachable connection, or integral connection; it may be mechanical connection or electrical connection, or direct connection or indirect connection via an intermediate medium, and it may be internal communication of two elements. For a person of ordinary skill in the art, the specific meanings of the above terms in the present disclosure may be understood according to specific situations.

Unless explicitly specified and defined otherwise, in the description of the present disclosure, it should be understood that terms such as “first”, “second”, etc. adopted in the present disclosure are intended to describe various information. However, the information should not be limited to these terms, and these terms are merely intended to distinguish the same type of information from each other. For example, “first” information can also be called as “second” information without departing from the scope of the present disclosure; and similarly, the “second” information may also be called as the “first” information.

Unless explicitly specified and defined otherwise, the term “and/or” used in the present disclosure includes any and all combinations of one or more relevant listed items.

### Embodiment 1

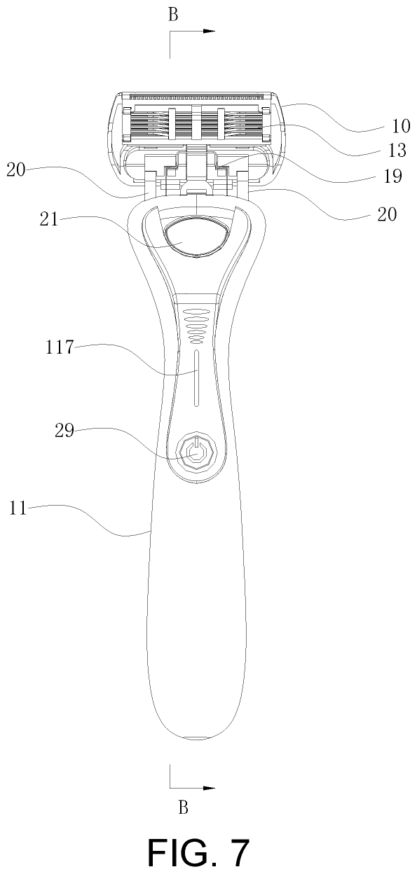

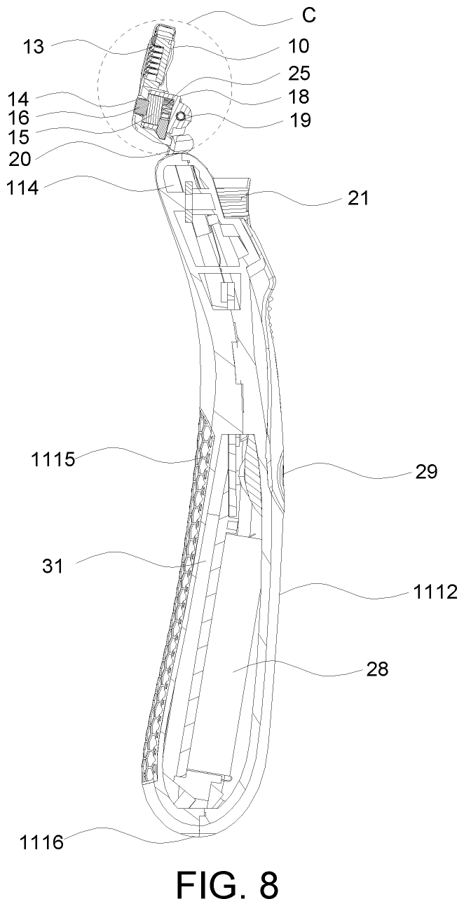

For facilitating description, unless specified otherwise, the vertical direction described hereinafter is consistent with the vertical direction in FIG. 7, the horizontal direction described hereinafter is consistent with the horizontal direction in FIG. 7, and the front and rear direction described hereinafter is consistent with the horizontal direction in FIG. 8.

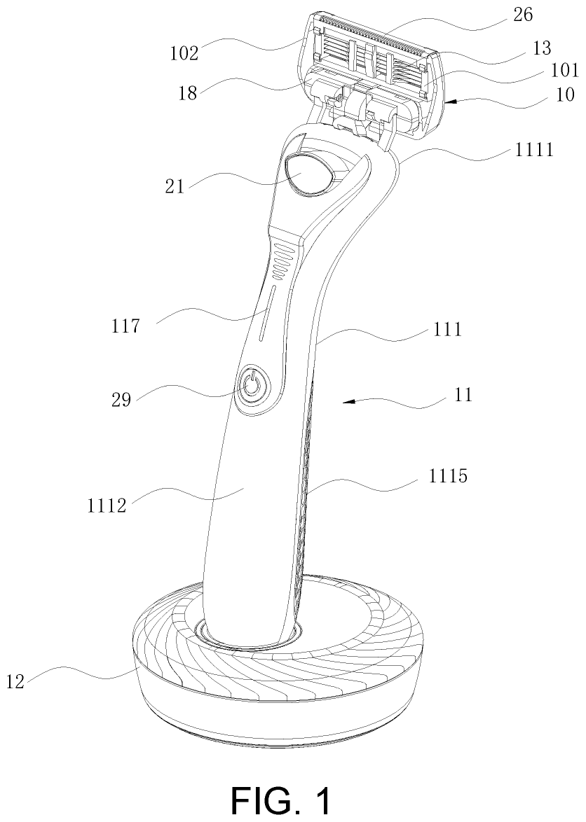

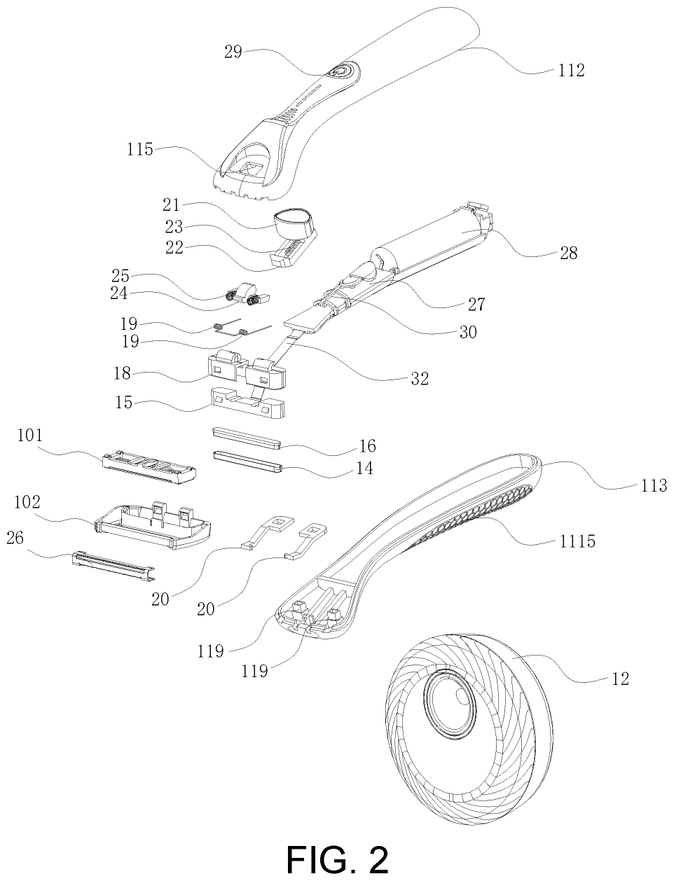

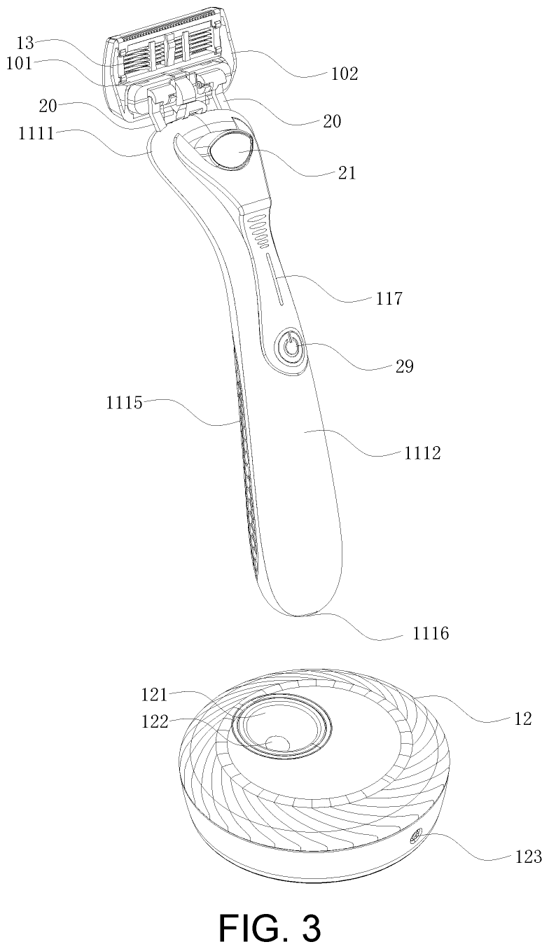

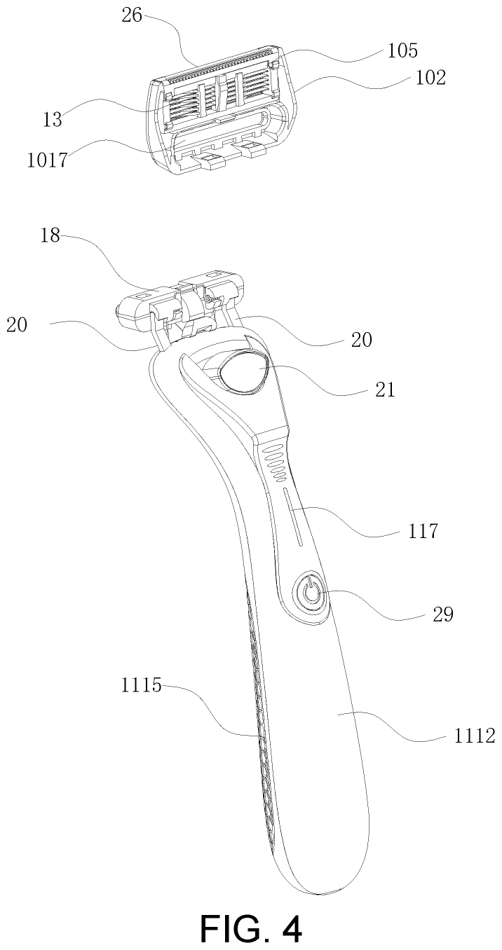

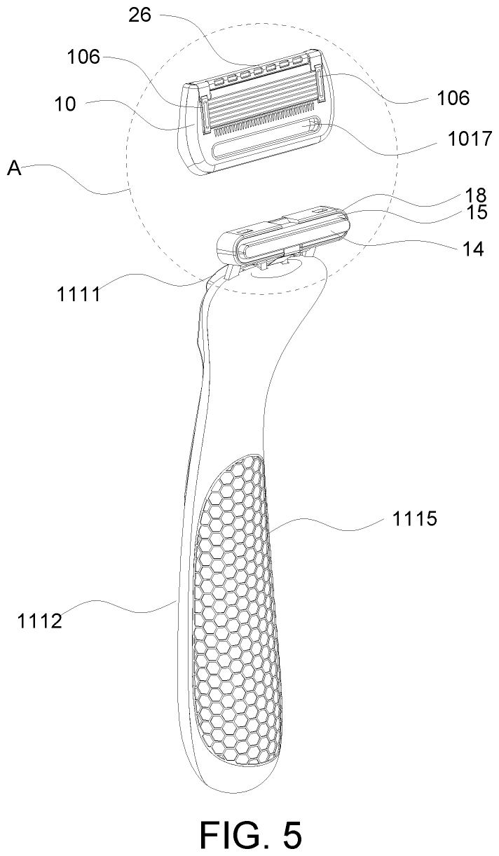

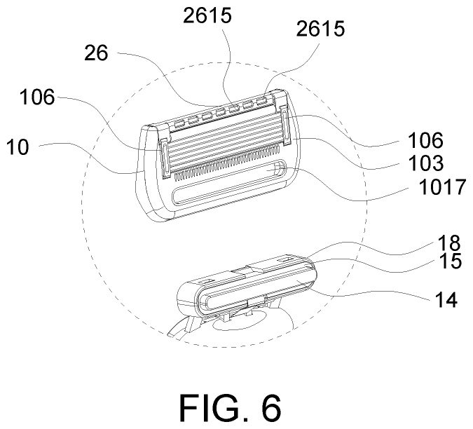

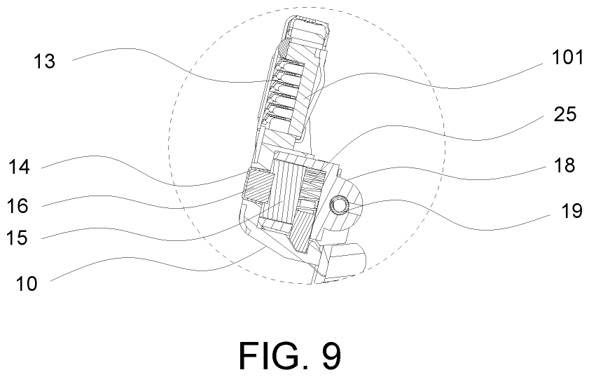

As shown in FIG. 1 to FIG. 9, a cooling/heating shaver includes a cutter head 10, a handle 11, a blade group 13, a tactile sheet 14, a heat transfer block 15 and an energy module 16. The energy module 16 is a semiconductor and is capable of heating and cooling. The blade group 13 includes a plurality of blades arranged in sequence.

The blade group 13 is detachably fixed on an outer side of the cutter head 10 for easy assembly and replacement. The energy module 16 is disposed inside the cutter head 10 against the tactile sheet 14; the tactile sheet 14 is disposed on a side of the energy module 16 close to the blade group 13, and the heat transfer block 15 is disposed on the other side of the energy module 16; and the cutter head 10 is connected to the handle 11. The tactile sheet 14, the energy module 16 and the heat transfer block 15 are sequentially stacked on the cutter head 10 so that the overall space is more compact. The blade group 13 and tactile blocks 141 of the tactile sheet 14 are located on the same surface of the cutter head 10; and when the blade group 13 is used for shaving, the tactile blocks 141 of the tactile sheet 14 abut against the skin, one side of the energy module 16 is connected to the tactile sheet 14, the other side of the energy module 16 is connected to the heat transfer block 15, and the heat transfer block 15 can transfer the heat from the other side of the energy module 16 to the handle 11. When the tactile sheet is set to ice compress mode, the heat transfer block 15 transfers the heat to the other side to the handle 11, which is beneficial to the heat dissipation of the energy module 16, so that the temperature of the handle 11 is raised to achieve an effect of warming the hand, and at the same time, energy can be sufficiently utilized. The heat transfer block 15 is a semiconductor having good thermal conductivity, which is beneficial to heat transfer; and the heat transfer block 15 can further play a role of heat conduction, exporting the heat generated on the other side of the energy module 16, so that heat generation and heat dissipation of the energy module 16 reach a balance point, and therefore, the normal operation of the energy module 16 is maintained. Before shaving, the energy module 16 heats the tactile sheet 14 abutting against the skin to relax pores and soften the hair; and after shaving, the energy module 16 cools the tactile sheet 14 abutting against the skin to tighten the skin, shrink pores and eliminate the tingling sensation by applying cold compress on the skin.

In one of embodiments, a support frame 111 of the handle 11 includes an upper housing 112 and a lower housing 113, which are detachably connected and form a hollow structure. Both the upper housing 112 and the lower housing 113 are provided with protruding holes 116 and frame holes 118.

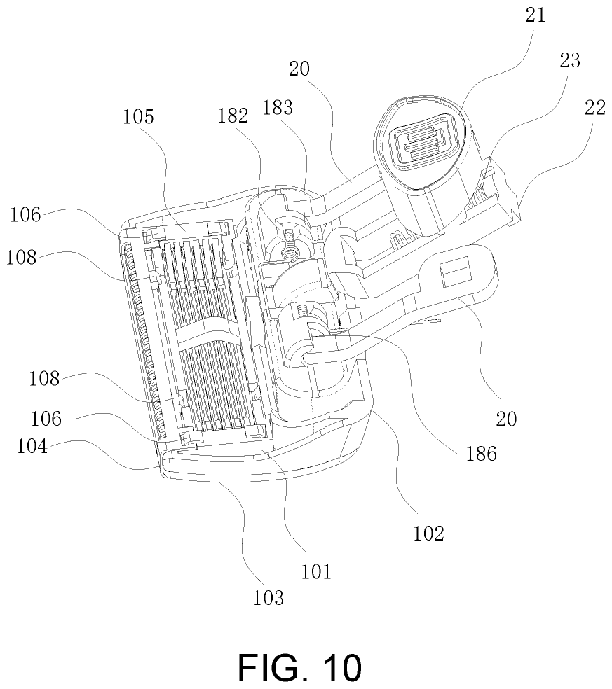

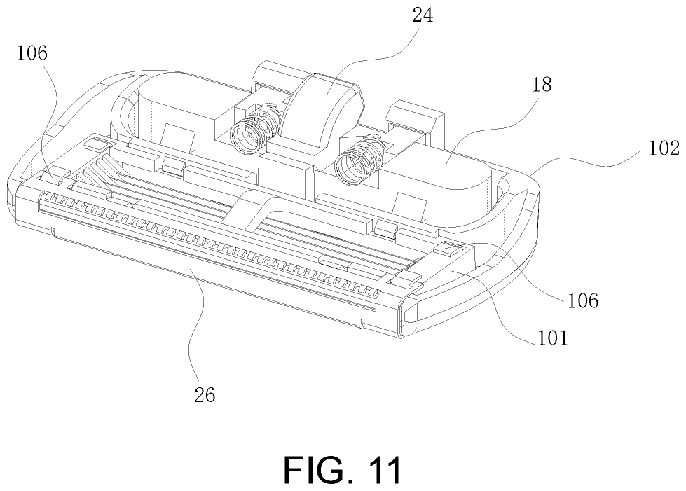

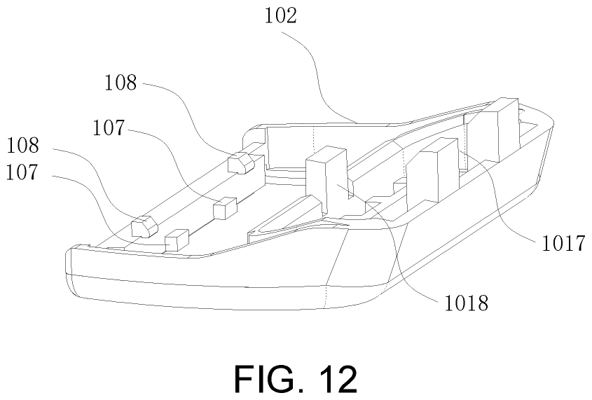

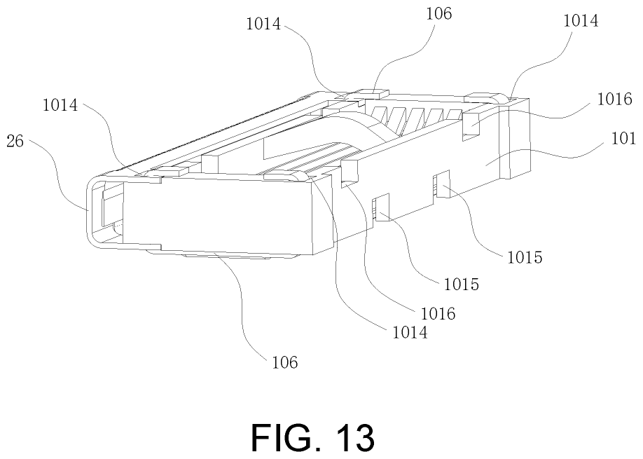

As shown in FIG. 10 to FIG. 13, in one of the embodiments, the cutter head 10 includes a fixed cover 101 and a cutter head body 102. The fixed cover 101 covers the cutter head body 102, the cutter head body 102 is provided with a groove body, a plurality of supporting blocks 107 and a plurality of anti-off blocks 108 are disposed on an edge of the groove body, the supporting blocks 107 are located below the anti-off blocks 108, the fixed cover 101 is provided with a plurality of first embedded grooves 1015 and a plurality of second embedded grooves 1016, the plurality of first embedded grooves 1015 correspond to the plurality of supporting blocks 107 one by one, and the plurality of second embedded grooves 1016 correspond to the plurality of anti-off blocks 108 one by one. The fixed cover 101 is mounted in the groove body; the supporting blocks 107 embed into the first embedded grooves 1015 to support the fixed cover 101; the anti-off blocks 108 embed into the second embedded grooves 1016 so that the cutter head body 102 and the fixed cover 101 are relatively fixed; and the separation of the cutter head body 102 from the fixed cover 101 can be achieved by applying an external force to make the anti-off blocks 108 elastically deformed. The blade group 13 is detachable fixed on an outer side of the fixed cover 101. A blade slot 1012 is provided on the outer side of the fixing cover 101, and the blade group 13 is mounted in the blade slot 1012.

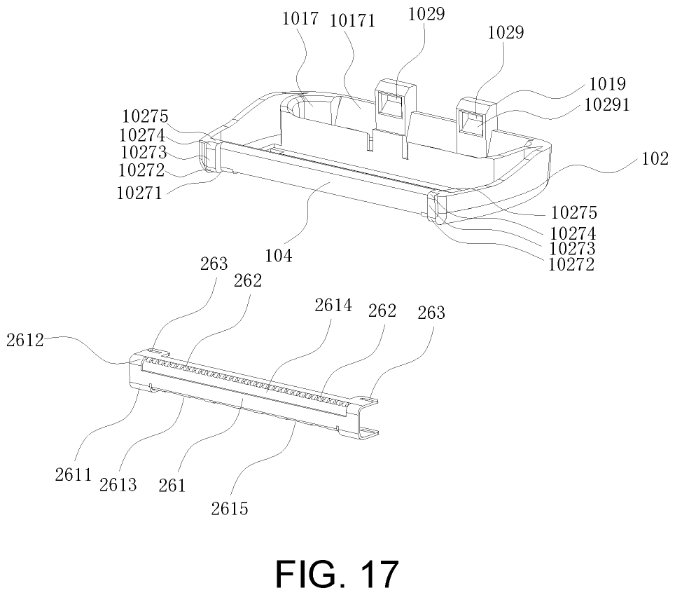

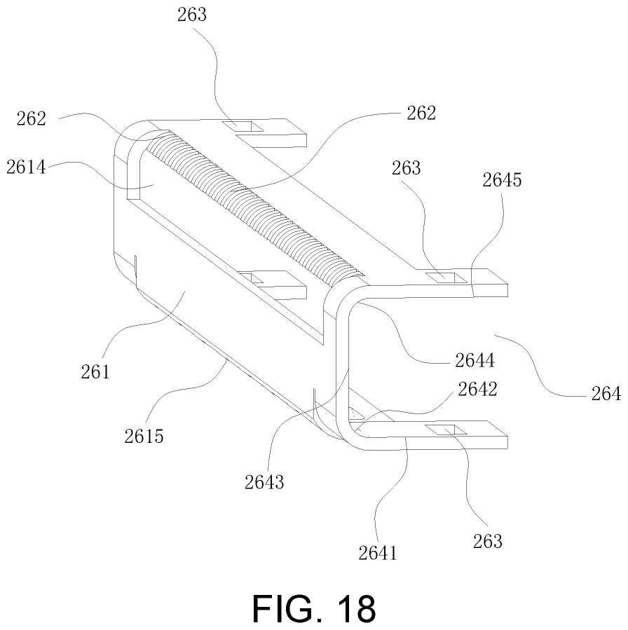

As shown in FIG. 10 to FIG. 13, FIG. 17 and FIG. 18, in one of the embodiments, the cooling/heating shaver further includes a sideburn cutter group 26; and the cutter head 10 is provided with a first mounting surface 103, a second mounting surface 104 and a third mounting surface 105. The first mounting surface 103, the second mounting surface 104 and the third mounting surface 105 are connected in sequence, the first mounting surface 103 is a front side surface of the fixed cover 101 of the cutter head 10, the second mounting surface 104 is an upper side surface of the cutter head body 102 of the cutter head 10, and the third mounting surface 105 is a rear side surface of the fixed cover 101 of the cutter head 10. The first mounting surface 103 is arranged facing away from the third mounting surface 105, the blade group 13 is mounted on the first mounting surface 103, the cutter head 10 is provided with buckles 106, the sideburn cutter group 26 is provided with clamping grooves 263, and is mounted on the second mounting surface 104 through cooperating the clamping grooves 263 with the buckles 106; and the sideburn cutter group 26 is located on an upper end of a cutter holder 261, and the blade group 13 is located on a front end of the cutter holder 261.

In one of the embodiments, the sideburn cutter group 26 includes a cutter holder 261 and scrapers 262 mounted on the cutter holder 261; and the cutter holder 261 is provided with a positioning groove 264, which passes through the cutter holder 261, and a section of the cutter holder 261 is U-shaped. The second mounting surface 104 is provided with a first positioning block 1025, a second positioning block 1026, a first engaging block 1027 and a second engaging block 1028; the first positioning block 1025 and the second positioning block 1026 are separately located at two ends of the second mounting surface 104, and the first positioning block 1025 is spaced apart from the second positioning block 1026. The first engaging block 1027 and the second engaging block 1028 are spaced apart between the first positioning block 1025 and the second positioning block 1026, the first positioning block 1025 is connected to the first engaging block 1027, and the second positioning block 1026 is connected to the second engaging block 1028. The cutter holder 261 is clamped between the first positioning block 1025 and the second positioning block 1026 so that the cutter holder 261 is positioned. Both the first engaging block 1027 and the second engaging block 1028 are engaged in the positioning groove 264, and both ends of the cutter holder 261 abut against the first engaging block 1027 and the second engaging block 1028 respectively, and the cutter holder 261 is stably supported by the first engaging block 1027 and the second engaging block 1028.

The positioning groove 264 is provided with a first inner wall 2641, a second inner wall 2642, a bottom wall 2643, a third inner wall 2644 and a fourth inner wall 2645, which are connected in sequence; the first inner wall 2641 and the fourth inner wall 2645 are parallel to each other and are both perpendicular to the bottom wall 2643, and the second inner wall 2642 and the third inner wall 2644 are both arc-shaped. Both the first engaging block 1027 and the second engaging block 1028 are provided with a first side wall 10271, a second side wall 10272, a top wall 10273, a third side wall 10274 and a fourth side wall 10275, which are connected in sequence; two ends of the first inner wall 2641 abut against the first side walls 10271 of the first engaging block 1027 and the second engaging block 1028 respectively; two ends of the second inner wall 2642 abut against the second side walls 10272 of the first engaging block 1027 and the second engaging block 1028 respectively, two ends of the third inner wall 2644 abut against the third side walls 10274 of the first engaging block 1027 and the second engaging block 1028 respectively; two ends of the fourth inner wall 2645 abut against the fourth side walls 10275 of the first engaging block 1027 and the second engaging block 1028 respectively; and two ends of the bottom wall 2643 abut against the top walls 10273 of the first engaging block 1027 and the second engaging block 1028 respectively, so as to make the cutter holder 261 and the first engaging block 1027, the second engaging block 1028 fit completely, to facilitate the installation of the cutter holder 261 and reduce the friction between the cutter holder 261 and the cutter head during use. A residue discharging cavity is formed between the positioning groove 264 and the second mounting surface 104. The first inner wall 2641 and the fourth inner wall 2645 extend toward the fixed cover 101 and are provided with clamping grooves 263, and the buckles 106 are disposed on the fixed cover 101. When the cutter head 10 is assembled, firstly, the blade group 13 is mounted on the cutter head body 102 through the fixed cover 101; and then the cutter holder 261 of the sideburn cutter group 26 is engaged with the cutter head body 102 through the positioning groove 264; and then the cutter holder 261 of the sideburn cutter group 26 is connected to the fixed cover 101 through the clamping grooves 263 and the buckles 106, so as to facilitate the installation and disassembly of the sideburn cutter group 26 and the blade group 13.

A first arc surface 2611 and a second arc surface 2612 are provided on an outer side of the cutter holder 261, and they are located on two sides of the upper end of the cutter holder 261. The first arc surface 2611 is close to a front end of the cutter head 10 and the first mounting surface 103, and the second arc surface 2612 is close to a rear end of the cutter head 10 and the third mounting surface 105. The first arc surface 2611 and the second arc surface 2612 make the user more comfortable when the cutter holder 261 is in contact with the skin. The first arc surface 2611 is parallel to the second inner wall 2642, the second arc surface 2612 is parallel to the third inner wall 2644, the first arc surface 2611 is provided with a first mounting groove 2613, the second arc surface 2612 is provided with a second mounting groove 2614, the first mounting groove 2613 and the second mounting groove 2614 are spaced apart along the arrangement direction of the first mounting surface 103 and the third mounting surface 105, the first mounting groove 2613 is close to the first mounting surface 103, and the second mounting groove 2614 is close to the third mounting surface 105. Residue discharging holes 2615 are disposed in the bottom wall 2643 of the first mounting groove 2613, and there are a plurality of residue discharging holes 2615, which are arranged at intervals. Both the residue discharging holes 2615 and the second mounting groove 2614 communicate with the positioning groove 264, and the second mounting groove 2614 communicates with the residue discharging holes 2615 through the residue discharging cavity formed by the positioning groove 264 and the second mounting surface 104. The second mounting groove 2614 is provided with a plurality of scrapers 262, which are arranged in sequence along the extending direction of the positioning groove 264, and arrangement direction of the scrapers 262 is the same as that of the residue discharging holes 2615. When the sideburn cutter group 26 of the cooling/heating shaver is used to shave sideburns, in order to prevent the blade group 13 on the first mounting surface 103 from touching the skin, the scrapers 262 of the sideburn cutter group 26 will not touch the skin when the blade group 13 is in use, the blade group 13 is located at the front end of the cutter head 10, and the scrapers 262 of the sideburn cutter group 26 are disposed at a rear end of an upper end of the cutter head 10, the residue discharging holes 2615 of the sideburn cutter group 26 are arranged at the front end of the upper end, so that the sideburn cutter group 26 and the blade group 13 do not affect each other during use, thereby avoiding accidental shaving.

In one of the embodiments, the buckles 106 are metal plates, the fixed cover 101 is provided with buckle holes 1014, which run through the fixed cover 101, two buckle holes 1014 are respectively disposed on two sides of the fixed cover 101, and there are two buckles 106, which are respectively mounted on two sides of the fixed cover 101 and cooperate with the two buckle holes 1014. When the cutter holder 261 of the sideburn cutter group 26 is installed, the two clamping grooves 263 on the two sides of the cutter holder 261 are respectively aligned with the two buckle holes 1014 on the two sides of the fixed cover 101. One end of each buckles 106 bends to abut against the second mounting surface 104 after passing through one of the buckle holes 1014 and one of the clamping grooves 263; and the other end of each buckles 106 bends to abut against the second mounting surface 104 after passing through the other buckle hole 1014 and the other clamping groove 263 on the same side.

In one of the embodiments, the cooling/heating shaver further includes a connecting seat 18 rotatably mounted on the handle 11 and torsion springs 19 mounted on the connecting seat 18. One end of each torsion spring 9 is connected to the handle 11, and the other end of each torsion spring 9 is connected to the connecting seat 18, the cutter head 10 is mounted on the connecting seat 18, and the connection between each torsion spring 19 and the connecting seat 18 and the handle 11 includes fixed connection, detachable connection and/or abutment. Each torsion spring 19 is provided with a first torsion arm 191 and a second torsion arm 192. There are two torsion springs 9, which are mounted on the connecting seat 18. The first torsion arms 191 of the torsion springs 19 are connected to the handle 11, and the second torsion arms 192 of the torsion springs 19 are connected to each other and then connected to the connecting seat 18. The cutter head 10 is mounted on the connecting seat 18, which can drive the cutter head 10 to rotate around the handle 11. When in use, the cutter head 10 can swing according to the curved surface of the skin to fit the skin so that the shaving effect is better. The torsion springs 19 limit the connecting seat 18 to swing within a certain range and control the connecting seat 18 to drive the cutter head 10 to reset after shaving.

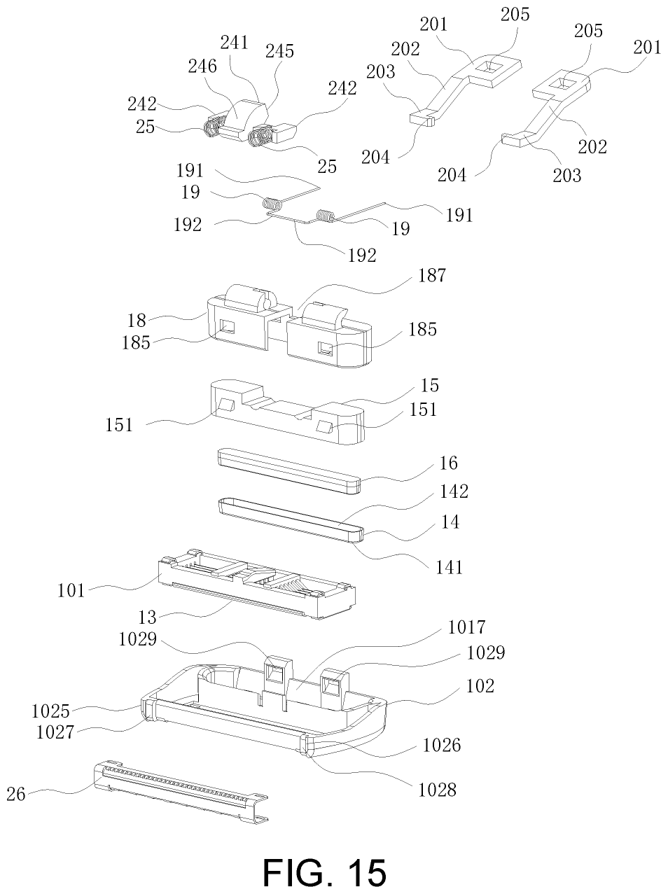

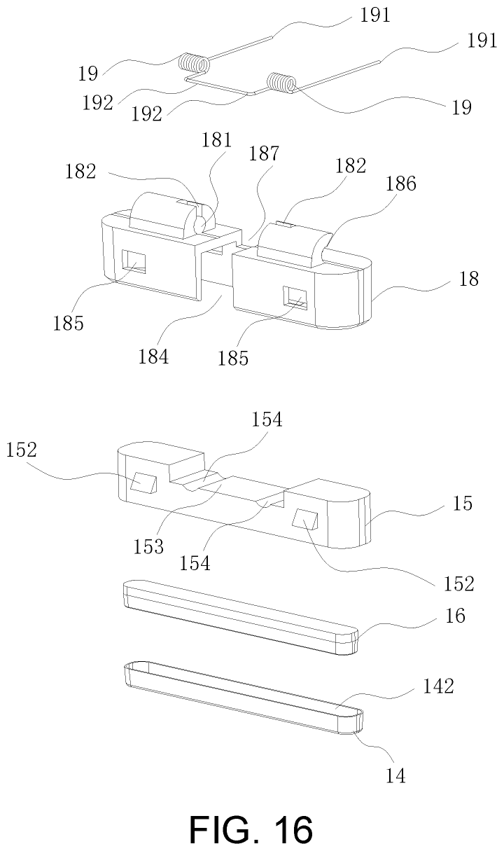

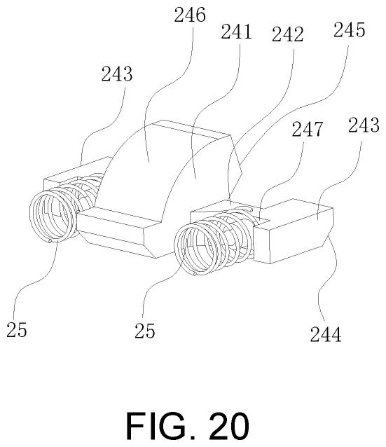

As shown in FIG. 10 to FIG. 16 and FIG. 20, in one of the embodiments, the cooling/heating shaver further includes connecting frames 20 mounted on the handle 11. One end of each connecting frame 20 is mounted on the handle 11, the connecting seat 18 is rotatably mounted on the other end of each connecting frame 20. The connecting seat 18 is provided with limiting grooves 181, and the torsion springs 19 are mounted in the limiting grooves 181. One end of each torsion spring 19 is connected to the handle 11, and the other end of each torsion spring 19 is connected to the connecting seat 18. The cutter head 10 is provided with a sleeve groove 1017, the connecting seat 18 is clamped in the sleeve groove 1017, the connecting seat 18 rotates around the connecting frames 20, and the cutter head 10 rotates with the connecting seat 18, so that the blade group 13 or the sideburn cutter group 26 can fit the skin during shaving. The cutter head 10 is detachably connected to the connecting seat 18 through the sleeve groove 1017.

In one of the embodiments, the cooling/heating shaver further includes a pushing seat 21, a sliding seat 22, a first spring 23, a clamping seat 24 and second springs 25; and by driving the pushing seat 21 to move, the sliding seat 22 can be driven to slide.

The handle 11 is provided with a sliding groove 114, a pressing hole 115 and protruding holes 116. Both the pressing hole 115 and the protruding holes 116 communicate with the sliding groove 114. The sliding seat 22 is slidably disposed in the sliding groove 114 in the handle 11 and can slide out from the protruding holes 116; and the pushing seat 21 protrudes out of the pressing hole 115, thereby facilitating manual driving. The sliding seat 22 is slidably disposed in the sliding groove 114, and the pushing seat 21 is connected to the sliding seat 22 and extends out of the sliding groove 114 through the pressing hole 115. One end of the first spring 23 is connected to the sliding seat 22, the other end of the first spring 23 is connected to an inner wall of the sliding groove 114, and the connection at both ends of the first spring 23 may be fixed connection or detachable connection or abutment. The protruding holes 116 are located on a moving path of the sliding seat 22. When the pushing seat 21 is driven to slide upwards, the sliding seat 22 moves upward and protrudes out of the protruding holes 116. When the pushing seat 21 is released, under the action of the first spring 23, the pushing seat 21 and the sliding seat 22 are reset, and the sliding seat 22 slides back into the sliding groove 114.

The cutter head 10 is provided with second extension blocks 1019, which are located on an edge of the sleeve groove 1017, and are provided with connecting holes 1029. The clamping seat 24 is slidably disposed on the connecting seat 18 and is located on the moving path of the sliding seat 22, the connecting holes 1029 are located on a moving path of the clamping seat 24. One end of each second springs 25 is connected to the clamping seat 24, and the other end of each second springs 25 is connected to the connecting seat 18. The connection of the second springs 25 can be fixed connection or detachable connection or abutment. The clamping seat 24 is clamped into the connecting holes 1029 under the actions of the second springs 25 so that the connecting seat 18 is connected to the cutter head 10. When the cutter head 10 needs to be disassembled, drive the sliding seat 22 to slide out of the protruding holes 116 and push the clamping seat 24 to move, the clamping seat 24 is separated from the connecting holes 1029, the cutter head 10 is removed, the connecting seat 18 is separated from the sleeve groove 1017, and thus, the separation of the connecting seat 18 from the cutter head 10 is completed.

In one of the embodiments, the handle 11 is provided with a boss 120, on which a U-shaped finger groove 1201 is formed, and the pushing seat 21 is located in the finger groove 1201. The surface of the boss 120 is inclined, and the pushing seat 21 is located in an extension direction of the surface of the boss 120; when the shaver is in use, the user's finger abut against the surface of the boss 120; when needing to drive the pushing seat 21 to move, move the finger along the surface of the boss 120 into the finger groove 1201 to realize the driving of the push seat 21; and move the finger along the surface of the boss 120 in a direction away from the finger groove 1201 to reach the control button 29 to switch cooling or heating, so as to change the temperature of the shaver while using it.

In one of the embodiments, the connecting seat 18 is provided with a first accommodating groove 184, limiting holes 185 and a seat groove 187. Both the limiting holes 185 and the seat groove 187 communicate with the first accommodating groove 184, and the clamping seat 24 is slidably disposed in the seat groove 187. The heat transfer block 15 is mounted in the first accommodating groove 184 and is provided with a supporting groove 153 communicating with the seat groove 187, guide grooves 154 are disposed on a bottom wall 2643 of the supporting groove 153. When the clamping seat 24 is slidably disposed in the seat groove 187, the clamping seat 24 abuts against the bottom wall 2643 of the supporting groove 153, and the second springs 25 are located in the guide grooves 154, so that the clamping seat 24 slides stably and at the same time radial deformation of the second springs 25 can be avoided. The heat transfer block 15 is further provided with clamping blocks 152, which are elastic. When the heat transfer block 15 is mounted in the first accommodating groove 184, the clamping blocks 152 are clamped into the limiting holes 185, and thus the heat transfer block 15 is stably mounted in the first accommodating groove 184 of the connecting seat 18.

One side of the energy module 16 is connected to the heat transfer block 15. The tactile sheet 14 is provided with a second accommodating groove 142 and is sleeved on the energy module 16 by the second accommodating groove 142. One side of the energy module 16 is connected to the heat transfer block 15, and the remaining sides of the energy module 16 are wrapped by the tactile sheet 14 to avoid heat loss, so that the heat of the energy module transfers is transferred between the heat transfer block 15 and the tactile sheet 14.

The sleeve groove 1017 is a through groove and passes through front and rear sides of the cutter head 10. After the connecting seat 18 is mounted in the sleeve groove 1017, the energy module 16, the heat transfer block 15 and the tactile sheet 14 are all located inside the sleeve groove 1017. The tactile sheet 14 is located on the front side of the cutter head 10, so it is convenient to contact with the user's skin.

In one of the embodiments, two sides of the seat groove 187 are both provided with semicircular blocks. Each semicircular block is provided with a pivot hole 186, a limiting groove 181, an assembling groove 182 and a guide arm groove 183, which are all communicate with the pivot holes 186. One end of each connecting frame 20 is rotatably mounted in each pivot hole 186. The pivot holes 186 are provided with avoidance grooves, which communicate with the pivot holes 186, so as to prevent the square bars 202 of the connecting frames 20 from interfering with the semicircular blocks during rotation. The torsion springs 19 are mounted in the limiting holes 185. The assembling grooves 182 are disposed on the end surfaces of the semicircular blocks and extend along the axis direction of the semicircular blocks. The guide arm grooves 183 are disposed on the circumferential sides of the semicircular blocks and extend along the circumferential direction of the semicircular blocks, and the assembling grooves 182 intercommunicate with the guide arm grooves 183. When the torsion springs 19 are mounted in the limiting grooves 181, the first torsion arms 191 first move axially and penetrate into the assembling grooves 182, then, the first torsion arms 191 move circumferentially to enter the guide arm grooves 183, and finally connects with the handle 11 so as to realize the positioning of the torsion springs 19 and the first torsion arms 191 of the torsion springs 19; when the connecting seat 18 rotates, the first torsion arms 191 slide along the guide arm grooves 183, so that the guide arm grooves 183 prevent the torsion spring 19 from moving axially and disengaging from the limit groove 181.

In one of the embodiments, the sleeve groove 1017 is provided with a first inclined inner wall 10171. The second extension blocks 1019 are located on the first inclined inner wall 10171. The inner wall opposite to the first inclined inner wall 10171 is provided with a first gap and a second gap, which are spaced apart, and an elastic plate 1018 is formed between the first gap and the second gap. The elastic plate 1018 is located on a moving path of the clamping seat 24 away from the connecting holes 1029; when the cutter head 10 is mounted on the connecting seat 18, the connecting seat 18 is clamped by inner walls of the sleeve groove 1017, and the connecting seat 18 is also clamped by the elastic plate 1018 and the first inclined inner wall 10171. When the clamping seat 24 is separated from the connecting holes 1029 so that the cutter head 10 is separated from the connecting seat 18, the clamping seat 24 abuts and pushes the elastic plate 1018 to deform and move away from the connecting seat 18, increasing the width of the sleeve groove 1017, which facilitates the separation of the connecting seat 18 from the cutter head 10. the clamping seat 24, not only can realize the connection between the connecting seat 18 and the cutter head 10, but also can facilitate the separation of the cutter head 10 from the connecting seat 18.

In one of the embodiments, the connecting holes 1029 are provided with second inclined inner walls 10291, and the cross-sections of the connecting holes 1029 gradually reduce in the direction away from the clamping seat 24, so that the clamping seat 24 is locked into the connecting holes 1029 to a certain depth and limited so as to prevent the clamping seat 24 from completely passing through the connecting holes 1029. The clamping seat 24 is provided with inclined outer walls 244 adapted to the second inner inclined walls 10291.

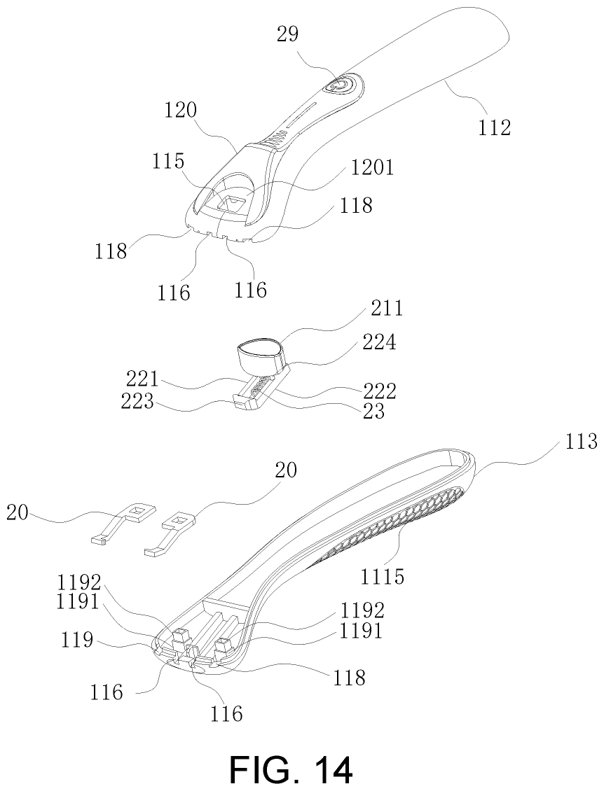

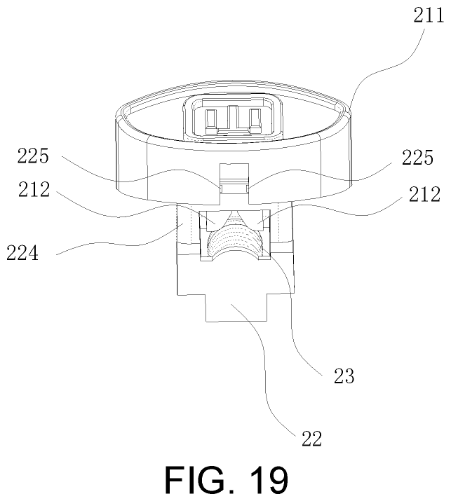

As shown in FIG. 14 to FIG. 20, the lower housing 113 is provided with two convex seats 119 corresponding to the two connecting frames 20 one by one, and the two connecting frames are distributed as mirror images. Each convex seat 119 includes a supporting column 1191 and a sleeve 1192, which are both square. Each connecting frame 20 includes a first square plate 201, a square bar 202, a second square plate 203 and a clamping hook 204, which are connected in sequence. The clamping hook 204 is pivoted to the connecting seat 18. The first square plate 201 is provided with a square hole 205, the cross section of which is the same size and shape as the cross section of the sleeve. The cross section of the supporting column 1191 is greater than the cross section of the square hole 205. The first square plate 201 is sleeved on the sleeve 1192 through the square hole 205 and abuts against the supporting column 1191 so as to realize the connection between each connecting frame 20 and the handle 11. The lower housing 113 is provided with a square column clamped into a tube hole of the sleeve 1192. After the connecting frames 20 are mounted on the lower housing 113 through the first square plates 201, the upper housing 112 covers on the lower housing 113. The square column is clamped into the tube hole of the sleeve 1192, which can not only connect the lower housing 113 and the upper housing 112, but also prevent the connecting frames 20 from detaching.

For comfortable grip, the handle 11 is in an arc-shaped as a whole. The first square plate 201 is parallel to the second square plate 203. The square bar 202 is obliquely disposed, so that when the cutter head 10 is mounted on the handle 11 through the connecting seat 18, the cutter head 10 can be inclined upward at a certain elevation angle, which is convenient for the blade group 13 to shave.

Both the upper housing 112 and the lower housing 113 are provided with two frame holes 118; after the upper housing 112 and the lower housing 113 are connected, one of the frame holes 118 of the upper housing 112 cooperates with one of the frame holes 118 of the lower housing 113, so that the square bar 202 of one of the connecting frames 20 can pass through; and the other frame hole 118 of the upper housing 112 cooperates with the other frame hole 118 of the lower housing 113 to allow the square bar 202 of the other connecting frame 20 to pass through.

In one of the embodiments, the sliding seat 22 includes a first sliding bar 221, a second sliding bar 222, a limiting bar 223 and a connecting block 224. The first sliding bar 221 and the second sliding bar 222 are spaced apart. One end of the limiting bar 223 is connected to the first sliding bar 221, and the other end of the limiting bar 223 is connected to the second sliding bar 222. The first spring 23 is located between the first sliding bar 221 and the second sliding bar 222. One end of the connecting block 224 is connected to the first sliding bar 221 and the second sliding bar 222, and the other end of the connecting block 224 is connected to the pushing seat 21.

Both the upper housing 112 and the lower housing 113 are provided with two protruding holes 116; after the upper housing 112 and the lower housing 113 are connected, one of the protruding holes 116 of the upper housing 112 cooperates with one of the protruding holes 116 of the lower housing 113 to allow the first sliding bar 221 to pass through; and the other protruding hole 116 of the upper housing 112 cooperates with the other protruding hole 116 of the lower housing 113 to allow the first sliding bar 221 to pass through. The limiting bar 223 is located outside of the sliding groove 114 to prevent the entire sliding seat 22 from sliding into the sliding groove 114, and the clamping seat 24 can also be pushed to move. One end of the first spring 23 abuts against the inner wall between the two protruding holes 116, and the other end of the first spring 23 directly or indirectly abuts against the first sliding bar 221 and the second sliding bar 222. The first sliding bar 221, the second sliding bar 222, the limiting bar 223 and the connecting block 224 are integrally formed.

In one of the embodiments, the pushing seat 21 includes a pushing block 211 and reverse hooks 212. The connecting block 224 is provided with jacks 225, one end of each reverse hook 212 is connected to the pushing block 211, and the other end of each reverse hook 212 are hooked on a side surface of the connecting block 224 through a jack 225.

In one of the embodiments, the clamping seat 24 includes a sliding block 241, first extension blocks 242 and insertion blocks 243. Both sides of the sliding block 241 are provided with the first extension blocks 242, on which the insertion blocks 243 are disposed, and the insertion blocks 243 are provided with inclined outer walls 244 matching the inclined inner walls of the connecting holes 1029. The sliding block 241 is provided with an abutted wall 245 abutting against the limiting bar 223 of the sliding seat 22. Third mounting grooves 247 are formed by enclosing the sliding block 241, the first extension blocks 242 and the insertion blocks 243 together, and the second springs 25 are mounted in the third mounting grooves 247. The sliding block 241 is further provided with an arc guide wall 246; when the sliding block 241 slides, the insertion blocks 243 is separated from the connecting holes 1029, the second torsion arms 192 of the torsion springs 19 slide along the arc guide wall 246, so that the second torsion arms 192 abutting against the connecting seat 18 are separated from the connecting seat 18, which facilitating shaking the cutter head 10 to separate the connecting seat 18.

As shown in FIG. 1 to FIG. 8, in one of the embodiments, the cooling/heating shaver further includes a control circuit board 27, a battery 28, a control button 29 disposed on the handle 11 and a light emitting sheet 30 electrically connected to the control circuit board 27. The battery 28 can store power and dose not need a direct power cord during shaving, which makes it easy to carry and use. The handle 11 is further provided with a mounting cavity 31, and the control circuit board 27 and the battery 28 are both mounted in the mounting cavity 31. The control button 29, the battery 28 and the energy module 16 are all electrically connected to the control circuit board 27; the energy module 16 is electrically connected to the control circuit board 27 through a cable 32.

The handle 11 is provided with a light transmission window 117 opposite to the light emitting sheet 30. The light beam emitted by the light emitting sheet 30 is emitted from the light transmission window 117 to achieve the purpose of prompting the user.

The control button 29 has a first control position and a second control position; when the control button 29 is at the first control position, the current of the control circuit board 27 flows along a first direction, and the light emitting sheet 30 emits a first light beam; and if the first light beam is green, it prompts the user that the shaver is in a cooling state. When the control button 29 is at the second control position, the current of the control circuit board 27 flows opposite to the first direction, and the light emitting sheet 30 emits a second light beam; if the second light beam is red, it prompts the user that the shaver is in a heating state. When the current of the control circuit board 27 flows in two opposite directions, the cooling and heating of the energy module 16 made of semiconductors can be achieved respectively, and the light emitting sheet 30 can also emit two light beams of different colors, respectively.

In one of the embodiments, the cooling/heating shaver further includes a charging stand 12, which facilitates storing and charging the cooling/heating shaver. The charging stand 12 is provided with a charging slot 121 on which the cooling/heating shaver is positioned. A charging connector 122 is disposed in the charging slot 121. One end of the handle 11 is inserted into the charging slot 121 and is provided with a first charging port 1116 adapted to the charging connector 122. The first charging port 1116 is electrically connected to the battery 28, and the charging stand 12 is provided with a second charging port 123 electrically connected to the charging connector 122. The second charging port 123 can be connected with an external power cord to charge the battery 28 through the charging stand 12.

### Embodiment 2

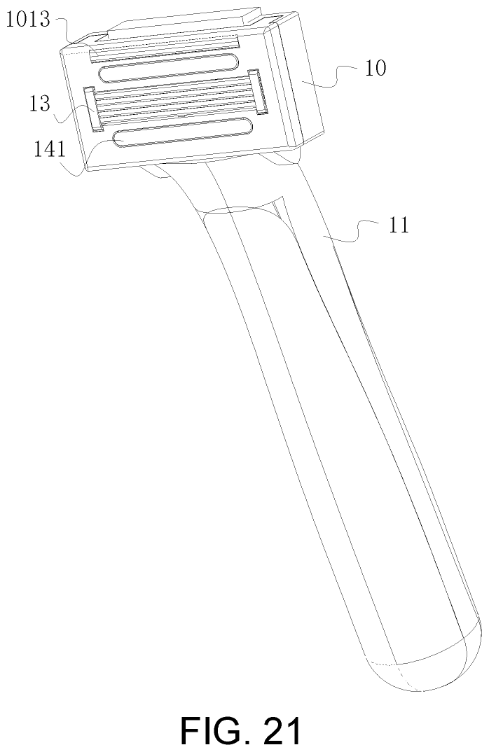

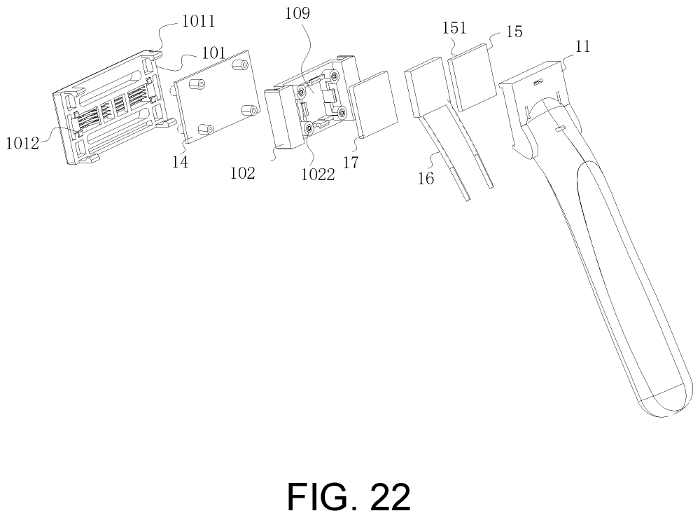

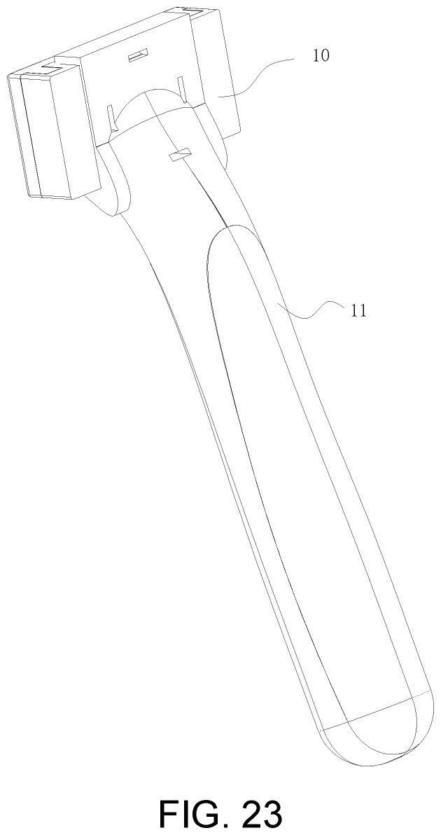

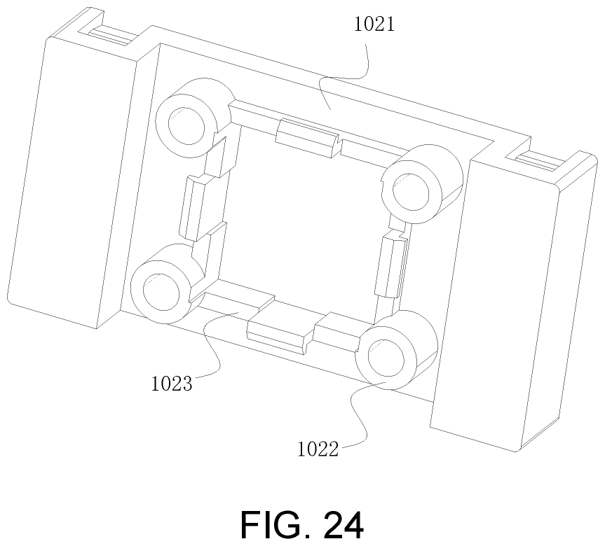

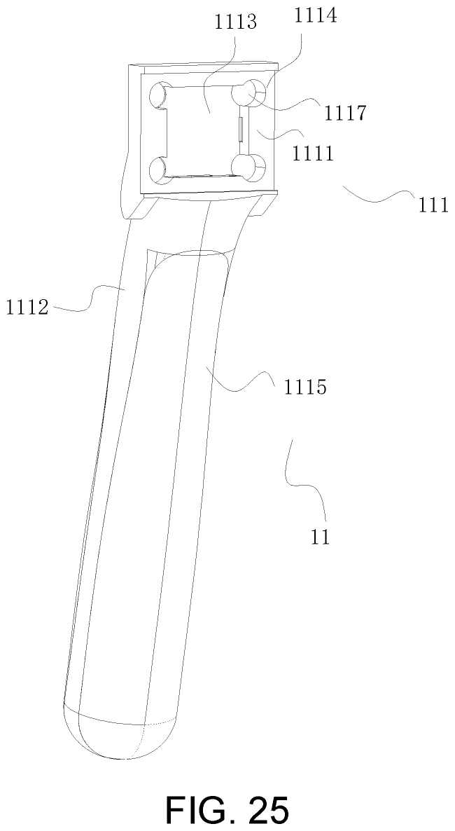

As shown in FIG. 21 to FIG. 25, a cooling/heating shaver includes a cutter head 10 and a handle 11; the cutter head 10 includes a fixed cover 101, a cutter head body 102, a blade group 13, a tactile sheet 14, a heat transfer block 15, an energy module 16 and a heat inducing block 17.

The fixed cover 101 is provided with a blade slot 1012, the blade group 13 is mounted on the blade slot 1012, which facilitates the replacement of blade group 13. The cutter head body 102 is provided with a groove. The fixed cover 101 is disposed on the cutter head body 102, so that an accommodating cavity is formed between the cutter head body 102 and the fixed cover 101; and the tactile sheet 14, the heat inducing block 17, the energy module 16 and the heat transfer block 15 are stacked in sequence in the accommodating cavity to make the overall space more compact; the cutter head body 102 is connected to the handle 11, and the heat transfer block is disposed on the bottom of a through groove, so that the heat transfer block 15 can transfer heat on the other side of the energy module 16 to the handle 11; when the tactile sheet is set to ice compress mode, the heat transfer block 15 transfers the heat from the other side to the handle 11, which is beneficial for the heat dissipation of the energy module 16, so that the temperature of the handle 11 is raised to achieve an hand warming effect, which sufficiently utilizes energy at the same time. Both the heat transfer block 15 and the heat inducing block 17 are semiconductors having the function of one-way transmission of heat energy. When the electrodes of a battery 28 are switched, the energy output surfaces of the semiconductors will switch between cooling and heating so as to achieve hot compress and cold compress. The heat transfer block 15 can further play a role of heat conduction, exporting the heat generated on the other side of the energy module 16, achieving a balance between heat generation and heat dissipation of the energy module 16, and maintaining the normal operation of the energy module 16.

The handle 11 includes a support frame 111, which is a metal frame, and metal has the performance of heat conduction, thereby facilitating heat conduction; the support frame 111 includes a fixed part 1111 and a hand-holding part 1112. The hand-holding part 1112 is provided with anti-slip parts 1115. The fixed part 111 is provided with a heat conduction surface 1113 on a side close to the cutter head body 102, and a side of the heat transfer block 15 close to the handle 11 is a heat transfer surface 151, which is bonded to the heat conduction surface 1113 to facilitate heat transfer. The area of the heat transfer surface 151 is smaller than or equal to the area of the heat conduction surface 1113, so that the heat of the heat transfer block 15 can be transferred to the heat conduction surface 1113 and the heat is not easy to disperse. In other embodiments, the area of the heat transfer surface 151 is equal to the area of the heat conduction surface 1113; the hand-holding part 1112 is a hollow housing with openings on the top and bottom respectively, so as to reduce the weight, and meanwhile, the heat is concentrated on a surface of the hand-holding part 1112, which facilitates warming the hand; and the anti-slip parts 1115 are two plastic blocks respectively disposed in the two openings. The shape of the anti-slip parts 1115 can fit the shape of a human hand so that it is easy to hold, and meanwhile, the plastic material is easy to process, so that the anti-slip parts 1115 have smooth curves, which is convenient for holding.

An engaging groove 1021 is disposed on a side of the cutter head body 102 close to the handle 11, and the fixed part 1111 is embedded in the engaging groove 1021 to complete the connection between the cutter head body 102 and the handle 11 while preventing heat loss. A fixed groove 1114 is disposed on a side of the fixed part 1111 close to the cutter head body 102; the groove 109 of the cutter head body 102 is a through groove which goes straight to the bottom of the fixed groove 1114; four corners of the through groove are provided with engaging columns 1022 which are disposed on a side of the cutter head body 102 close to the handle 11, and baffle bars 1023 are connected between the engaging columns 1022 to prevent the energy module 16 and the heat transfer block 15 inside the accommodating cavity from sliding out; four corners of the fixed groove 1114 are provided with column grooves 1117 corresponding to the engaging columns 1022, and the engaging columns 1022 are embedded in the column grooves 1117 so as to enable firmer connection between the cutter head body 102 and the handle 11. The energy module 16 is surrounded layer by layer by the baffle bars 1023, the engaging columns 1022, the fixed groove 1114 and the engaging groove 1021 to prevent the heat loss of the energy module 16, which makes the heat from one side of the energy module 16 flows through the heat transfer block 15, and the heat from the other side flows through the heat inducing block 17.

The energy module 16 is a semiconductor cooling block; when the energy module 16 is powered on, one side of the energy module 16 absorbs heat, and the other side releases heat; the tactile sheet 14 is disposed on a side of the energy module 16 close to the blade group 13; the tactile sheet 14 can transfer the heat of the energy module 16 and can be in direct contact with the skin to achieve the effect of ice compress or hot compress on the skin and improving the shaving experience; after positive or negative electrodes of the energy module 16 are exchanged, the mode of ice compress or hot compress can be switched; the tactile sheet 14 and the cutter head body 102 can be by means of snap-fit or threaded connection, etc.

Four engaging pins 1011 for connecting the cutter head body 102 are disposed on a side of the fixed cover 101 close to the cutter head body 102. Convex blocks are disposed on the ends of the engaging pins 1011, and the convex blocks extend towards the inside of the fixed cover 101 facilitating securing the fixed cover 101; clamping grooves 263 corresponding to the engaging pins 1011 are disposed on a side of the cutter head body 102, and the convex blocks are engaged inside the clamping grooves 263; the four engaging pins 1011 are paired to clamp the blade body. The engaged structure is not only convenient for disassembly and assembly, but also improves the stability of the connection.

The tactile sheet 14 is a metal block, and the metal material is beneficial for heat transfer; the tactile sheet 14 is provided with two tactile blocks 141 on the side close to the fixed cover 101. The fixed cover 101 is provided with two openings for the tactile blocks 141 to pass through. The two tactile blocks 141 are respectively disposed on two sides of the blade slot 1012; the tactile blocks 141 are strip-shaped, and the length of the tactile blocks 141 is equal to the length of the blade slot 1012; when the blade group 13 moves on the skin for shaving, the tactile blocks 141 can cover the shaved skin, so that cold compress or hot compress is applied on the skin in time.

The blade group 13 includes five blades and two fixing bars for securing the blades. The fixed cover 101 further includes three blade holders, i.e. a first blade holder, a second blade holder and a third blade holder which are arranged in sequence at the bottom of the blade slot 1012 along the length direction of the blade slot 1012; the second blade holder is disposed in the middle of the blade slot 1012, and the first blade holder and the third blade holder are respectively disposed on both sides of the second blade holder; clamping pieces of the first blade holder, the second blade holder and the third blade holder are obliquely arranged to make the blades more stable and secure; five bulges are disposed on two side walls along the length direction of the blade slot 1012, and gaps for clamping the blades are disposed on the bulges facilitating securing the blades.

A lubricating bar 1013 is disposed on one side of the fixed block, and the lubricating bar 1013 can play the effect of lubrication; anti-slip bars are disposed on two ends of the fixing block, and the anti-slip bars can increase friction; a battery 28 and a control panel are disposed inside the handle 11. The control panel is electrically connected to the battery 28 and the energy module 16 respectively, and the control panel is used for controlling the temperature and heating/cooling mode of the energy module 16.

### Embodiment 3

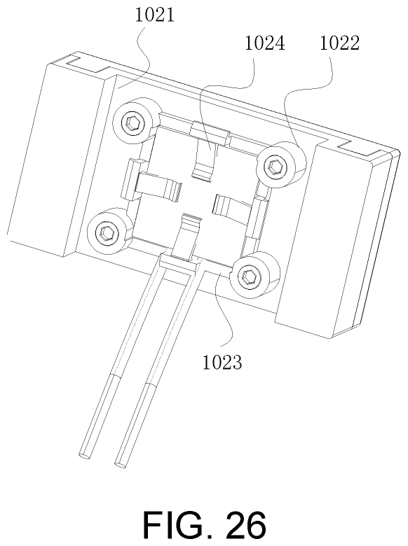

As shown in FIG. 26, the difference from embodiment 2 is that, the ends of the through groove are provided with four elastic sheets 1024. The elastic sheets 1024 are disposed on four inner walls of the through groove and are used for securing the energy module 16 to prevent the energy module 16 from sliding out; the elastic sheets 1024 are made of an elastic silica gel material, which can exert a reverse force on the heat transfer block 15 making the overall structure more compact, and increasing the heat conduction effect.

The above-mentioned embodiments are not exhaustively enumerated on the basis of the present disclosure. In addition, there may be a plurality of other embodiments not listed. Any replacements and improvements made without departing from the concept of the present disclosure shall fall within the protection scope of the present disclosure.

What is claimed is:

1. A cooling/heating shaver, comprising a cutter head, a handle, a blade group, a tactile sheet, a heat transfer block and an energy module,
wherein, the blade group is detachably fixed on an outer side of the cutter head, and the energy module is disposed inside the cutter head, the tactile sheet is disposed on a side of the energy module close to the blade group, the heat transfer block is disposed on the other side of the energy module, and the cutter head is connected to the handle.

2. The cooling/heating shaver of claim 1, wherein the cutter head comprises a fixed cover and a cutter head body, the fixed cover covers the cutter head body, and the blade group is detachable fixed on an outside of the fixed cover, the cutter head body is provided with a groove so that an accommodating cavity is formed between the cutter head body and the fixed cover, and the tactile sheet and the energy module are disposed inside the accommodating cavity.

3. The cooling/heating shaver of claim 1, wherein the cutter head further comprises a heat inducing block, which is disposed between the tactile sheet and the energy module.

4. The cooling/heating shaver of claim 1, further comprising: a connecting seat rotatably mounted on the handle and torsion springs mounted on the connecting seat, wherein one end of each torsion spring is connected to the handle, the other end of each torsion spring is connected to the connecting seat, and the cutter head is mounted on the connecting seat.

5. The cooling/heating shaver of claim 4, further comprising connecting frames mounted on the handle, wherein the connecting frames are mounted on the handle, the connecting seat is rotatably mounted on the connecting frames, the connecting seat is provided with limiting grooves, the torsion springs are mounted in the limiting grooves, one end of each torsion spring is connected to the handle, the other end of each torsion spring is connected to the connecting seat, the cutter head is provided with a sleeve groove, and the connecting seat is clamped in the sleeve groove.

6. The cooling/heating shaver of claim 4, further comprising: a pushing seat, a sliding seat, a first spring, a clamping seat and second springs,
the handle is provided with a sliding groove, a pressing hole and protruding holes, the pressing hole and the protruding holes are all connected with the sliding groove, the sliding seat is slidably disposed in the sliding groove, the pushing seat is connected to the sliding seat and extends out of the sliding groove through the pressing hole, one end of the first spring is connected to the sliding seat, and the other end of the first spring is connected to an inner wall of the sliding groove, and the protruding holes are located on a moving path of the sliding seat, and
the cutter head is provided with connecting holes, the clamping seat is slidably disposed on the connecting seat and is located on the moving path of the sliding seat, the connecting holes are located on the moving path of the clamping seat, one end of each second spring is connected to the clamping seat, and the other end of each second spring is connected to the connecting seat.

7. The cooling/heating shaver of claim 1, further comprising: a sideburn cutter group, the cutter head has a first mounting surface, a second mounting surface and a third mounting surface, wherein the first mounting surface, the second mounting surface and the third mounting surface are connected in sequence, the first mounting surface is set facing away from the third mounting surface, the blade group is mounted on the first mounting surface, the cutter head is provided with buckles, and the sideburn cutter group is provided with clamping grooves and is mounted on the second mounting surface through the cooperation of the clamping grooves and the buckles.

8. The cooling/heating shaver of claim 7, wherein the sideburn cutter group comprises a cutter holder and scrapers mounted on the cutter holder, the cutter holder is provided with a positioning groove, the positioning groove runs through the cutter holder, and the second mounting surface is provided with a first positioning block, a second positioning block, a first engaging block and a second engaging block, the first positioning block is spaced apart from the second positioning block, and the first engaging block and the second engaging block are spaced apart between the first positioning block and the second positioning block, the cutter holder is clamped between the first positioning block and the second positioning block, and the first engaging block and the second engaging block are both clamped in the positioning groove, and
the positioning groove has a first inner wall, a second inner wall, a bottom wall, a third inner wall and a fourth inner wall that are connected in sequence, the first inner wall and the fourth inner wall are parallel to each other and are both perpendicular to the bottom wall, the second inner wall and the third inner wall are both arc-shaped, each first engaging block and each second engaging block have a first side wall, a second side wall, a top wall, a third side wall and a fourth side wall connected in sequence, two ends of the first inner wall abut against the first side walls of the first engaging block and the second engaging block respectively, and two ends of the second inner wall abut against the second side walls of the first engaging block and the second engaging block respectively, two ends of the third inner wall abut against the third side walls of the first engaging block and the second engaging block respectively, two ends of the fourth inner wall abut against the fourth side walls of the first engaging block and the second engaging block respectively, and two ends of the bottom wall abut against the top walls of the first engaging block and the second engaging block respectively, and
a first arc surface and a second arc surface are provided on the outer side of the cutter holder, wherein the first arc surface is parallel to the second inner wall, the second arc surface is parallel to the third inner wall, the first arc surface is provided with a first mounting groove, the second arc surface is provided with a second mounting groove, the first mounting groove and the second mounting groove are spaced apart along an arrangement direction of the first mounting surface and the third mounting surface, residue discharging holes are provided on the bottom wall of the first mounting groove, the residue discharging holes and the second mounting groove are connected with the positioning groove, a plurality of scrapers disposed in the second mounting groove, and the scrapers are disposed sequentially along the extending direction of the positioning groove.

9. The cooling/heating shaver of claim 1, further comprising: a control circuit board, a battery, a control button disposed on the handle and a light emitting sheet electrically connected to the control circuit board, the handle further has a mounting cavity, the control circuit board and the battery are both mounted in the mounting cavity, and the control button, the battery and the energy module are all electrically connected to the control circuit board, and
the control button has a first control position and a second control position, when the control button is at the first control position, a current of the control circuit board flows along a first direction, and the light emitting sheet emits a first light beam, and when the control button is at the second control position, the current of the control circuit board flows opposite to the first direction, and the light emitting sheet emits a second light beam.

10. The cooling/heating shaver of claim 9, further comprising: a charging stand, wherein the charging stand is provided with a charging slot, a charging connector is disposed in the charging slot, and one end of the handle is inserted into the charging slot and is provided with a first charging port adapted to the charging connector, the first charging port is electrically connected to the battery, and the charging stand is provided with a second charging port electrically connected to the charging connector.

11. The cooling/heating shaver of claim 2, further comprising: a connecting seat rotatably mounted on the handle and torsion springs mounted on the connecting seat, wherein one end of each torsion spring is connected to the handle, the other end of each torsion spring is connected to the connecting seat, and the cutter head is mounted on the connecting seat.

12. The cooling/heating shaver of claim 3, further comprising: a connecting seat rotatably mounted on the handle and torsion springs mounted on the connecting seat, wherein one end of each torsion spring is connected to the handle, the other end of each torsion spring is connected to the connecting seat, and the cutter head is mounted on the connecting seat.

13. The cooling/heating shaver of claim 2, further comprising: a sideburn cutter group, the cutter head has a first mounting surface, a second mounting surface and a third mounting surface, wherein the first mounting surface, the second mounting surface and the third mounting surface are connected in sequence, the first mounting surface is set facing away from the third mounting surface, the blade group is mounted on the first mounting surface, the cutter head is provided with buckles, and the sideburn cutter group is provided with clamping grooves and is mounted on the second mounting surface through the cooperation of the clamping grooves and the buckles.

14. The cooling/heating shaver of claim 3, further comprising: a sideburn cutter group, the cutter head has a first mounting surface, a second mounting surface and a third mounting surface, wherein the first mounting surface, the second mounting surface and the third mounting surface are connected in sequence, the first mounting surface is set facing away from the third mounting surface, the blade group is mounted on the first mounting surface, the cutter head is provided with buckles, and the sideburn cutter group is provided with clamping grooves and is mounted on the second mounting surface through the cooperation of the clamping grooves and the buckles.

15. The cooling/heating shaver of claim 2, further comprising: a control circuit board, a battery, a control button disposed on the handle and a light emitting sheet electrically connected to the control circuit board, the handle further has a mounting cavity, the control circuit board and the battery are both mounted in the mounting cavity, and the control button, the battery and the energy module are all electrically connected to the control circuit board, and
the control button has a first control position and a second control position, when the control button is at the first control position, a current of the control circuit board flows along a first direction, and the light emitting sheet emits a first light beam, and when the control button is at the second control position, the current of the control circuit board flows opposite to the first direction, and the light emitting sheet emits a second light beam.

16. The cooling/heating shaver of claim 3, further comprising: a control circuit board, a battery, a control button disposed on the handle and a light emitting sheet electrically connected to the control circuit board, the handle further has a mounting cavity, the control circuit board and the battery are both mounted in the mounting cavity, and the control button, the battery and the energy module are all electrically connected to the control circuit board, and
the control button has a first control position and a second control position, when the control button is at the first control position, a current of the control circuit board flows along a first direction, and the light emitting sheet emits a first light beam, and when the control button is at the second control position, the current of the control circuit board flows opposite to the first direction, and the light emitting sheet emits a second light beam.
